(19) United States
(12) Patent Application Publication
(10) Pub. No.: US 2021/0207428 A1
(43) Pub. Date: Jul. 8, 2021

(54) OPTICALLY-TRANSPARENT, THERMALLY-INSULATING NANOPOROUS COATINGS AND MONOLITHS

(71) Applicant: THE REGENTS OF THE UNIVERSITY OF CALIFORNIA, Oakland, CA (US)

(72) Inventors: Laurent Pilon, Sherman Oaks, CA (US); Bruce S. Dunn, Los Angeles, CA (US); Sarah H. Tolbert, Encino, CA (US); Michal Marszewski, Los Angeles, CA (US); Yan Yan, Los Angeles, CA (US); Sophia C. King, Los Angeles, CA (US); Esther H. Lan, Los Angeles, CA (US); Danielle Butts, Los Angeles, CA (US); Patricia E. McNeil, Los Angeles, CA (US)

(73) Assignee: THE REGENTS OF THE UNIVERSITY OF CALIFORNIA, Oakland, CA (US)

(21) Appl. No.: 17/118,537

(22) Filed: Dec. 10, 2020

Related U.S. Application Data
(63) Continuation of application No. PCT/US2019/039019, filed on Jun. 25, 2019.
(60) Provisional application No. 62/696,420, filed on Jul. 11, 2018.
(60) Provisional application No. 62/689,548, filed on Jun. 25, 2018.

(51) Int. Cl. E06B 3/67; C01B 33/158; C01B 33/154; E06B 3/66; E06B 3/663; C03C 27/04

(52) U.S. Cl. CPC E06B 3/6715; C01B 33/1585; C03C 27/048; E06B 3/6612; E06B 3/66342; C01B 33/1543

(57) ABSTRACT

Materials and methods for preparing thick, mesoporous silica monolithic slabs and coatings with high transparency and low thermal conductivity are provided. The transparent silica materials are particularly suited for window or solar applications including insulation barriers for existing or new single, double pane windows or glass panel building components. The template-free, water-based sol-gel methods produce slabs or coatings by gelation of a colloidal suspension of silica or other oxide nanoparticles or by ambigel formation and then ageing and drying the gels under ambient conditions. Solvent exchanges with nonpolar, low-surface-tension solvents help to avoid cracking caused by drying stress. Mesoporous slabs can also be cast in molds on perfluorocarbon liquid substrates to reduce adhesion and enable gels to shrink freely during aging and drying without incurring significant stress that could cause fracture.

### CROSS-REFERENCE TO RELATED APPLICATIONS

This application claims priority to, and is a 35 U.S.C. § 111(a) continuation of, PCT international application number PCT/US2019/039019 filed on Jun. 25, 2019, incorporated herein by reference in its entirety, which claims priority to, and the benefit of, U.S. provisional patent application Ser. No. 62/689,548 filed on Jun. 25, 2018, incorporated herein by reference in its entirety, and which claims priority to, and the benefit of, U.S. provisional patent application Ser. No. 62/696,420 filed on Jul. 11, 2018, incorporated herein by reference in its entirety. Priority is claimed to each of the foregoing applications.

The above-referenced PCT international application was published as PCT International Publication No. WO 2020/005965 A1 on Jan. 2, 2020, which publication is incorporated herein by reference in its entirety.

### STATEMENT REGARDING FEDERALLY SPONSORED RESEARCH OR DEVELOPMENT

This invention was made with government support under Grant Number DE-AR0000738, awarded by the U.S. Department of Energy. The government has certain rights in the invention.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to thermally insulating monolithic or coating materials and methods of fabrication, and more particularly optically-transparent, thermally-insulating mesoporous ambigel materials and methods of ambient temperature and pressure fabrication that achieves thermal conductivity comparable to that of an aerogel while retaining high transmittance and low haze. Ambient temperature and pressure drying of ambigel eliminates the high cost of supercritical drying used for aerogels. The materials are particularly suited for applications with insulating windows or glass panels.

### 2. Background Discussion

Very low density, mesoporous materials such as aerogels, xerogels, hydrogels and cryogels have demonstrated low thermal conductivity making them useful as thermally insulating materials. These materials are also typically transparent or translucent making them candidates for applications where both thermal insulation and the passage of light are essential. One setting requiring transparent and thermal insulating materials is in windows and glass panel building components that produce unwanted heat transfer by conduction and convection.

According to the US Department of Energy, HVAC systems in commercial and residential buildings accounted for 14% of primary US energy consumption in 2013. About 30% of that energy, or 4.1 quadrillion BTU annually, was wasted as heat lost through the windows of the building. In 2015, 49 million homes in the United States, or 41% of all residences, still possessed single-pane windows in spite of the availability of multi-pane energy saving window products. Considering 66 million US homes have at least 10 windows, and, that windows are an essential component to building functionality, expanding the prevalence of insulating windows would play a considerable role in saving energy.

State-of-the-art windows consist of double-pane or, more rarely, triple-pane insulation glazing units (IGUs). The gaps between the glass panes are filled with air, a vacuum or low thermal conductivity gas such as argon, bromine, carbon disulfide, nitrogen, dichlorodifluoromethane, or krypton and is maintained at moderately low vacuum. This technology is not new and has been commercially available since the 1950s.

Recent improvements on this design include adding thin film coatings with low thermal emissivity to the inner or outer layers of double panes to further increase the thermal resistance to radiative heat transfer and to decrease infrared transmittance.

Silica aerogels have received much attention as potential optically-transparent thermal insulation because of their low effective thermal conductivity. In fact, due to their large porosities of more than 90%, silica aerogels can achieve an effective thermal conductivity as low as 0.013 W m⁻¹ K⁻¹ at ambient pressure and temperature. This thermal conductivity value is lower than that of air and argon as well as typical insulation materials such as polyurethane and phenolic foam.

Despite the extraordinary thermal insulating ability of aerogels, high initial cost and poor optical transparency have limited widespread consumer adoption of aerogel insulation for window applications. Although researchers have developed partially transparent aerogels, high optical transparency across the entire visible spectrum (400-800 nm) in monolithic aerogels has not been achieved. The relatively large haziness from strong light scattering by the largest pores (>30 nm) has limited the use of aerogels primarily to skylights, where optical transparency is not crucial. While examples of transparent aerogel thin-film coatings have been developed for window insulation, the gains in thermal resistance are insufficient to appreciably improve energy savings due to the small film thickness.

Prior technologies featuring high quality thermal insulation are also shown to be expensive and cannot act as a simple modifier to preexisting window systems. Thus, cost efficient, exceedingly transparent, insulating materials must be developed to replace a multi-pane dependent design and to create inherently insulating windows.

Recently, transparent mesoporous silica monoliths have found applications as optically-transparent supports in photocatalysis, optics, and laser amplification. They have also been used as ultralow refractive index substrates for waveguides and as optically-transparent thermal insulation in window solutions and in solar-thermal energy conversion.

Mesoporous silica monoliths can take various shapes (e.g., slabs, discs, rods) and feature large specific surface area and porosity, small pore size (2 nm to 50 nm), low effective thermal conductivity, and a low dielectric constant. They have been commonly used in adsorption, catalysis, and chromatography for their large surface area and porosity.

Mesoporous silica thin films or powders are often prepared using sol-gel methods. The synthesis typically uses organic templates (e.g., surfactants or block-copolymers) that form mesopores with controlled shape and diameter between 1.5 nm and 30 nm and porosity up to 80%. However, mesoporous silica monoliths are much more difficult to synthesize by a sol-gel method because the silica network is subjected to significant capillary forces during evaporation of the solvent present in the mesopores. These forces impose enormous stress on the silica network causing it to shrink during aging and drying. If the stress exceeds the compressive strength of the gel, the monolith cracks and will often crumble into powder.

Synthesis of thick mesoporous silica monolithic slabs that are both transparent and thermally insulating is even more challenging. First, achieving low thermal conductivity requires large porosity. Second, transparency requires that the slab's pores and surface roughness be much smaller than the wavelength of the incident visible light (400 nm to 700 nm) so as to minimize volumetric and surface scattering responsible for haze. However, mesoporous silica slabs with large porosity also tend to have larger pores that scatter light. For example, aerogels with porosity exceeding 80% have low thermal conductivity, but are typically hazy because of their wide pore size distribution with some pores exceeding 40 nm in diameter. Third, in addition to capillary forces and stress caused by evaporation, mesoporous silica slabs synthesized using sol-gel method may crack due to adhesion forces pinning the gel to the substrate. All mesoporous silica gels undergo significant shrinkage during aging and drying. Because gels are soft and fragile, opposing adhesion and compressive forces due to shrinkage almost inevitably result in cracking. In fact, adhesion forces are proportional to the footprint surface area of the gel, making it especially challenging to synthesize large slabs.

One solution to the cracking of mesoporous silica monoliths is supercritical drying that rendered difficult by the fact that (i) supercritical drying requires expensive high-pressure equipment and (ii) ambient drying may be time consuming and requires large volumes of organic solvents used in solvent exchange.

Synthesis of mesoporous silica monoliths can also be achieved by (1) scaffolding silica network with a secondary material or by (2) inducing flexibility in the silica network. Although successful, both strategies are complicated to implement, and most monoliths prepared using these methods are opaque.

Accordingly, there is a need for new fabrication methods for producing slabs or film coatings which displays high light transmittance and low haze with low thermal conductivity and materials that could be used in conjunction with a low-emissivity coating and applied to glass using a transparent adhesive.

### BRIEF SUMMARY

Mesoporous ambigel monoliths and coatings that have low thermal conductivity and high transparency and methods of fabrication are provided. The ambigel materials achieve thermal conductivity comparable to that of an aerogel while retaining high transmittance and low haze. These materials are particularly suited for window or glass construction applications. The transparent insulative coatings or monoliths are illustrated with silica ambigels. However, other metal oxides such as TiOx or ZrOx or combinations such as silica-titania and silica-zirconia can be used.

The transparent thermally insulating materials can be produced as individual structures such as a slab or they can be part of insulative systems such as an applied coating on glass, for example. In one illustration, a system of a combined porous silica (SiOx) slab with a low-emissivity coating on one side and a transparent adhesive on the other allows facile on-line application of the system to a sheet of glass is provided.

In another embodiment, the materials can be applied to a preinstalled window in a building with single or multiple pane windows to improve thermal insulation without purchasing an entirely new window. In a further embodiment, a porous silica slab or applied coating can be applied to one or more glass panes in multiple-pane windows to increase the window's thermal and radiative resistance. In this way, the system can help reduce waste and costs by simple incorporation with both modern manufacturing facilities and current products.

Sol-gel synthesis methods have been developed specifically to achieve small pores and a narrow pore size distribution while maintaining the structural integrity of the silica monolith. The ambiently dried silica ambigels can achieve a smaller and narrower pore size distribution resulting in larger visible transmittance and smaller thermal conductivity and haze compared to a supercritically dried silica aerogel of similar porosity and thickness.

To illustrate the methods of fabrication, monolithic silica ambigels were synthesized using two-sol procedures based on acid-catalyzed tetraethyoxysilane (TEOS) and a combination of methyltriethoxysilane (MTES) and TEOS precursors, both dried with nonpolar solvents at ambient temperature and pressure.

The TEOS/MTES ambigels were also synthesized with post gelation surface treatment of trimethylchlorosilane (TMCS), phenyltrichlorosilane (PTCS), or triethylchlorosilane (TECS). These surface treatments were used to create higher porosity ambigel structures, albeit with larger pores. Treatments with TMCS for example tend to make the slabs more porous and flexible than untreated slabs.

In addition to achieving excellent optical transparency and low thermal conductivity of synthesized gels, the comparison of gels with varying pore size and porosity provides insight into engineering porous insulation materials to more efficiently utilize a given porosity.

Ambient drying of silica gels, i.e., producing ambigels, is one method to achieve silica materials with small pore size and narrow pore size distribution. In contrast to (i) aerogels, which require supercritical (typically CO₂) drying techniques, and (ii) xerogels, which are dried in polar solvents, ambigel synthesis makes use of high vapor pressure, nonpolar drying solvents that can minimize the surface tension on the silica network. This avoids cracking and pore collapse in ambigels leading to a smaller pore size than in aerogels and a larger porosity than in xerogels.

Thus, ambient drying enables control of pore size which can be used to tune optical transmittance and thermal transport for any given porosity. Ambient temperature and pressure drying of the silica or silica-titania ambigel also eliminates the high cost of supercritical drying used for aerogels. Furthermore, hydrophobicity reduces moisture retention concerns in the product.

In another embodiment, transparent and thermally insulating mesoporous slabs comprising aggregated hollow or solid silica nanoparticles can be synthesized using sol-gel methods. The template-free water-based sol-gel methods of this embodiment can synthesize thick transparent and thermally insulating mesoporous silica monolithic slabs by gelation and drying of a colloidal suspension of silica nanoparticles under ambient conditions. The simple synthesis is readily scalable and offers promising materials for window solutions and solar-thermal energy conversion, for example.

Mesoporous silica slabs were synthesized on perfluorocarbon liquid substrates to reduce adhesion and enable the gels to shrink freely during aging and drying without incurring significant stress that could cause fracture. The free-standing nanoparticle-based mesoporous silica slabs were a few centimeters in diameter and several millimeters in thickness. The porosity was between 50% and 60% while the thermal conductivity ranged between 100 and 200 mW m⁻¹ K⁻¹. The diameter of silica nanoparticles and the mesopore width were smaller than 20 nm to achieve high transparency and low haze. Visible light transmittance exceeded 89% and haze was less than 2.6% for a 1.5-mm thick slab.

Accordingly, sol-gel derived silica ambigels can provide a cost-effective solution for manufacturing of thick, monolithic, window insulation materials. The key component of ambigel synthesis is the method of drying. In contrast to aerogels, which use expensive supercritical drying (typically CO₂) techniques, and xerogels, which are dried in polar solvents, ambigels utilize a high vapor pressure, nonpolar drying solvent that can minimize the surface tension on the silica surface to avoid cracking and pore collapse. Careful consideration of alkoxide precursors, solvent ratios, catalysts, and additives can also lead to a monolithic high porosity material with a microporous (pore width <2 nm) or mesoporous (pore width 2 nm to 50 nm) structure. Organic drying control chemical additives (DCCAs), such as formamide, have also been shown to achieve a more uniform pore size distribution and allow for ambient drying without cracking when added to the sol.

In another embodiment, the gels can be dried in reduced pressures between 0 and 1 atmosphere and/or increased temperatures between room temperature and 100° C. These conditions may increase the rate of drying without causing fracturing of the slab with some applications.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is a schematic cross-sectional diagram showing an optically clear insulative slab or coating mounted to a glass panel with an optional transparent adhesive according to one embodiment of the technology.

FIG. 2 is a schematic cross-sectional diagram of the optically clear insulative slab or coating mounted to a glass panel of FIG. 1 with a low-emissivity coating on one side of the glass panel according to another embodiment of the technology.

FIG. 3 is a schematic cross-sectional diagram of a dual pane widow formed from parallel glass panels with opposing insulative layers separated by an enclosed gas or vacuum gap according to another embodiment of the technology.

FIG. 4 is a schematic cross-sectional diagram of an asymmetric dual pane window with the insulated panel of FIG. 1 and a glass panel with a low-emissivity coating separated by a sealed gas filled or vacuum gap according to another embodiment of the technology.

FIG. 5 is a schematic functional block diagram of a method of ambient condition, sol-gel ambigel synthesis that allows control over pore size and distribution, transmittance and thermal conductivity according to another embodiment of the technology.

FIG. 6 is a schematic functional block diagram of a template-free sol-gel synthesis method of fabricating nanoparticle based mesoporous ambigels at ambient conditions according to another embodiment of the technology.

FIG. 7 is a schematic functional block diagram of a template-free sol-gel synthesis method of fabricating nanoparticle based mesoporous ambigels at hydrothermal conditions according to another embodiment of the technology.

FIG. 8A is a graph of N₂ Porosimetry adsorption isotherms of TEOS1 and MM-TEOS1 ambigels and SCD-TEOS1 aerogels.

FIG. 8B is a graph of corresponding pore size distributions for silica aerogel and ambigel samples of FIG. 8A.

FIG. 9A is a graph of transmittance of the TEOS1 and MM-TEOS1 ambigels and SCD-TEOS1 aerogels.

FIG. 9B is a graph of haze of the corresponding silica aerogel and ambigel samples of FIG. 9A highlighting transparency.

FIG.10 is a graph of thermal conductivity as a function of solid volume fraction for SCD-TEOS1 aerogel, TEOS ambigels and MM-TEOS ambigels.

### DETAILED DESCRIPTION

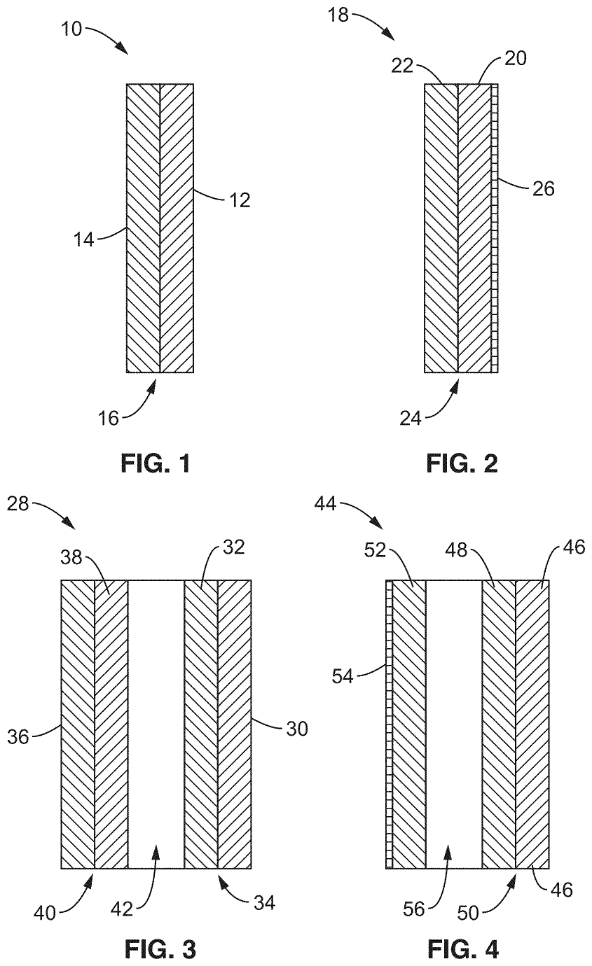

Referring more specifically to the drawings, for illustrative purposes, embodiments of the materials, system and methods for tuned, transparent thermally insulated substrates are generally shown. Several embodiments of the technology are described generally in FIG. 1 to FIG. 10 to illustrate the characteristics and functionality of the materials, methods and systems. It will be appreciated that the methods may vary as to the specific steps and sequence and the systems and materials may vary as to structural details without departing from the basic concepts as disclosed herein. The method steps are merely exemplary of the order that these steps may occur. The steps may occur in any order that is desired, such that it still performs the goals of the claimed technology.

Several illustrations of possible uses of the transparent thermal barrier coating or monolith combination with a transparent substrate such as a single pane glass window are shown in FIG. 1 through FIG. 4. These illustrations are not intended to be to scale or to exhaustive of all possible permutations of element positions of the single pane or double pane embodiments shown in the figures. It can be seen that the dimensions and characteristics of the thermal barrier materials as well as the capabilities of the window systems can be adjusted and tuned to different performance needs.

Turning now to FIG. 1, one embodiment 10 of a simple coating or slab thermal barrier 14 coupled to a glass substrate 12 is shown schematically. The thermal barrier 14 may be applied as a coating to the glass 12 or coupled to the glass 12 with a transparent adhesive 16. The thickness of the thermal barrier layer 14 can preferably range from approximately 0.5 mm to approximately 3 mm. The thermal barrier 14 may also be thinner or thicker than the glass substrate in some embodiments.

The preferred thermal barrier 14 is a microporous or mesoporous ambigel layer or monolith layer with a thermal conductivity equal to or less than about 0.030 W m⁻¹ K⁻¹, an optical transmittance equal to or greater than approximately 85% and haze of the thermal barrier 14 is preferably less than or equal to about 5% at 3 mm thickness.

In the alternative single pane embodiment 18 of FIG. 2, a low-emissivity (low-e) film or coating 26 is applied to one side of the glass substrate 20 and the thermal barrier 22 is mounted to the other side of the glass substrate 20. In this embodiment, the thermal barrier 22 is mounted to the glass substrate 20 with an optional transparent adhesive 24.

Low-e films or coatings 26 of various types are known in the art and serve the function of reflecting short-wave and/or long-wave infrared radiation and limiting heat transmission across the glass. The low-e film 26 can be placed on the room side or on the outdoor side of the glass substrate 20. The low-e film can further diminish the overall solar heat gain or heat loss through the single pane glass substrate 20. Other coatings such as hard coatings known in the art can also be applied to surfaces for scratch resistance.

The basic glass and thermal barrier combination as seen in FIG. 1 can also be incorporated into dual pane window designs as illustrated in FIG. 3 and FIG. 4. Such dual pane or triple pane window designs in the art typically provide substantially parallel transparent sheets separated by a gap that are held together and sealed by a frame (not shown).

In FIG. 3, a dual pane window embodiment 28 is formed with a first glass substrate 30 and first thermal barrier 32 that is paired with a second glass substrate 36 and second thermal barrier 38 and separated by a gap 42. The first thermal barrier 32 is joined to glass substrate 30 with a transparent adhesive layer 34 and the second thermal barrier 38 is joined to the second glass substrate 36 with transparent adhesive 40 in this embodiment. The gap 42 between thermal barriers is preferably evacuated or filled with an inert, low thermal conductivity gas such as argon, bromine, carbon disulfide, nitrogen, dichlorodifluoromethane, or krypton as found in conventional dual pane window designs in the art. The thermal barriers 32, 38 shown in the embodiment of FIG. 3 have the same dimensions and thermal insulating capabilities. However, the two barrier layers 32, 38 of the glass panes may also have different thicknesses and characteristics. In addition, the substrates 30, 36 are preferably made of glass but other transparent materials may also be used. The thermal barriers may also be coatings rather than slabs that may be applied without adhesive in other embodiments.

Asymmetric dual pane window designs are also possible. In the embodiment 44 shown in FIG. 4, one pane is formed with a first glass substrate 46 joined to a thermal barrier 48 with a transparent adhesive 50. The second pane is formed with a second glass substrate 52 that is separated from the first pane with a vacuum or gas filled gap 56. A low-e coating or film 54 is also mounted to the second glass substrate 52. In this illustration, the low-e film side of the window 44 could be an interior side to reflect heat back to the interior for cold weather applications or on the outside for warm weather applications.

To achieve the desired performance, sol-gel and nanoparticle-based methods of synthesis of thermal barrier coatings or ambigel/aggregate slabs were used. Synthesis schemes of thermal barrier coatings with high transparency and low thermal conductivity preferably produce small pores and a narrow pore size distribution while maintaining the structural integrity of the silica monolith or layer.

Although silica based ambigels are used to illustrate the fabrication methods, the methods can be adapted to use ambigels of other metal oxides or combinations of metal oxides. However, ambigels fabricated using sol-gel processing of silica, titania, zirconia or a combination of two or more, such as a silica-titania are particularly preferred.

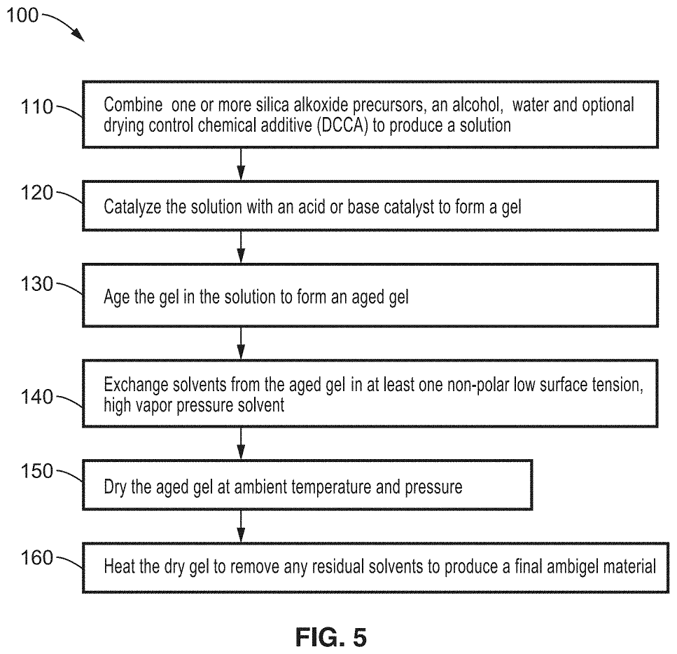

Referring now to FIG. 5, one synthesis method 100 for producing thermally insulating and transparent barrier coatings or monoliths is shown schematically. At block 110 of FIG. 5, the metal oxide precursors, suitable alcohol and water solvent are selected.

For silica ambigels, one or a combination of multiple silica alkoxide precursors, such as tetramethylorthosilane (TMOS), tetraethylorthosilane (TEOS), methyltriethoxysilane (MTES), methyltrimethoxysilane (MTMS), ethyltrimethyoxysilane (ETMS), or vinyltrimethoxysilane (VMTS) are preferred. In some embodiments, silicon-based polymers such as hexamethyldisiloxane (HMDS), hexamethyl-disilazane (HMDZ) or polydimethylsiloxane (PDMS) can be included as co-precursors with the silica alkoxide precursors.

The preferred alcohol is ethanol. However, methanol or propanol may also be used. The water used should be deionized.

An optional drying control chemical additive (DCCA), such as formamide, may be used to achieve a more uniform pore size distribution and a crack-free monolithic gel in one embodiment. The ratio of components used to form the initial solution at block 110 can also be selected to tune the characteristics (e.g. pore size and density) of the final material. For example, see Table 1.

At block 120 of FIG. 5, the combined solution is gelled with an acid or base catalyst to form a gel. A mold can be used to control final shape, thickness and curvature of the ambigel. In one embodiment, a surface modifying wash in a polar or nonpolar solvent can be used post gelation to achieve a desired property such as hydrophobicity or higher porosities by preventing both pore collapse and crosslinking when drying. Surface modifications may include end groups such as methyl groups, vinyl groups, or fluorine groups to replace silica ambigel surface (OH) groups using precursors such as trimethylchlorosilane (TMCS) or fluorotriethoxysilane.

The produced gel that is in a mold or on the surface of a substrate is then allowed to age for a period at ambient temperatures and pressures at block 130. Typically, the gels may age in the original solution of water, alcohol, precursors and DCCA from several hours to several days depending on the desired characteristics of the resulting structure. Surface modifications can take place before or after the aging of the gel.

After aging, the solvents can be exchanged one or more times at block 140. In one embodiment, the formed gel may be removed from the mold after gelation and aging occurs at block 130 and saturated with a nonpolar, low-surface-tension, high-vapor-pressure solvent such as cyclohexane, n-hexane, or n-pentane at block 140. The solvents are then evaporated off at room temperature and pressure until the ambigel monolith is dried at block 150.

In another embodiment, additional solvent exchanges are performed at block 140 and allowed to dry at block 150. The solvents can be exchanged multiple times with a progression of different solvents over time to further age the gel at block 140. For example, acetone solvent exchanged with cyclohexane.

In one embodiment, the structure is allowed to dry at block 150 in an ambient temperature and pressure environment of a hydrocarbon gas a such as n-heptane to resist further crosslinking during drying. In another embodiment, the aged gel is allowed to dry at block 150 at a reduced pressure between 0 and 1 atmosphere and at room temperature. In another embodiment, the aged gel is dried at ambient pressure and at an increased temperature between room temperature and 100° C. In another embodiment, drying that can be done under reduced pressure between 0 and 1 atmosphere and at a temperature above room temperature and less than the boiling point of the last solvent used during the solvent exchange step at block 140.

Finally, the dried gel may be heated to remove any residual solvents or hydrocarbons at block 160. In one embodiment, the dried gel is heated to 500° C. as a calcination step at block 160.

The resulting ambigel structure is optically transparent due to the creation of a narrow pore size distribution with a small mesoporous pore diameter, <20 nm, which minimizes visible light scattering. Thus, the haze of the silica ambigel is minimal, preventing virtually all distortion of an image through the porous silica. The resulting gel can also be made flexible due to surface modifications and the addition of organic groups to the gel network. This attribute can be beneficial in the application and integration of ambigel in window solutions. Some structural and optical properties of synthesized ambigels are shown in Table 2.

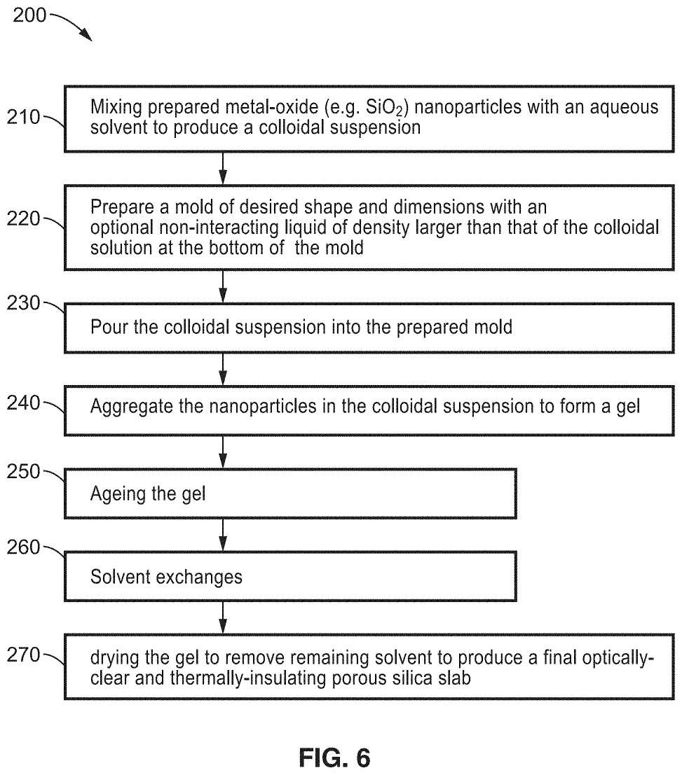

An alternative embodiment of a synthesis method 200 for manufacturing thermally insulating transparent barrier coating or slabs with the claimed performance capabilities is shown in FIG. 6. Nanoparticle based thin or thick films on a substrate or free-standing nanoparticle aggregate slabs with the desired optical transmittance, thermal conductivity and haze characteristics can be fabricated with this variation of the methods.

Oxide nanoparticles are prepared and mixed with at least one aqueous solvent to produce a colloidal suspension at block 210 of FIG. 6. Suitable nanoparticles that can be used may be solid, core-shell (e.g. ceria-silica) or hollow oxide particles. The nanoparticles preferably have a diameter of less than about 20 nm with particles in the range of about 5 nm to 7 nm particularly preferred.

In the illustration of FIG. 6, the colloidal suspension prepared at block 210 is then placed in a mold to ultimately form a monolithic slab structure. Optionally, the colloidal suspension can be placed on a coating of the bottom of the mold that will decrease roughness of the bottom surface of the final thermal barrier material. For example, the colloidal silica solution can be cast at block 230 on top of (i) a liquid metal (e.g., mercury, gallium, low-melting metal alloys) or (ii) perfluorocarbon liquid (e.g., DuPont™ Krytox® oils, 3M™ Fluorinert™ liquids) to reduce surface roughness and to lower the haze of the resulting slab. Liquid metal or perfluorocarbon liquid facilitates free development of the cast in a fashion similar to that seen with PTFE, ultimately providing slabs with a smoother surface.

Perfluorocarbon (PFC) liquids are selected as mold coatings because of (i) their omniphobic properties, ensuring immiscibility with the aqueous colloidal solution of silica nanoparticles, (ii) their high density, ensuring that the colloidal solution floats on the liquid substrate, and (iii) a large surface tension with water, ensuring flatness of the liquid-liquid interface. The latter enables the gels to shrink during aging and drying without experiencing significant stress that would otherwise lead to fractures. Casting of the colloidal suspension on top of the PFC liquid in a PTFE mold at room temperature at block 230 is particularly preferred.

At block 240, the colloidal solution of silica (or other oxide) nanoparticles is allowed to gel and the nanoparticles aggregate. The water can be partly driven off to drive gelation of the suspension.

After gelation, the gel is then aged at block 250 for a period of time to allow the evaporation of water from the gel. The aging period may range from a few hours to a few days. In one embodiment the gelling takes place over a period of 1 to 7 days. The gel typically shrinks during the aging process at block 250. Optionally, to prevent shrinkage at block 250 and to achieve higher porosity of the slabs, the remaining solvent in the pores of the gel can be exchanged at block 260 with a nonpolar, low-surface-tension, low-vapor-pressure solvent (e.g., cyclohexane, n-hexane, n-pentane). This solvent is then evaporated at ambient temperature and ambient pressure.

Once sufficiently gelled, the gel can be easily removed from the mold, handled by hand, and cut to desired shape and size with a thin wire. Afterwards, the gel can either be (i) slowly dried over the next 1 to 3 weeks to avoid cracking caused by “drying stress” or (ii) dried by solvent exchange with a nonpolar, low-surface-tension solvents such as ethanol, acetone, heptane etc. The solvent is then evaporated off at ambient temperature and ambient pressure until the material is dry.

In another embodiment, the gel is dried at block 270 in an reduced pressure environment between 0 and 1 atmosphere and at a temperature between room temperature and 100° C. In another embodiment, drying at block 270 is performed under reduced pressure between 0 and 1 atmosphere and temperature above room temperature and less than the boiling point of the last solvent used during the solvent exchange step.

Optionally the dried slab may be calcinated at block 270 to remove any remaining solvents or gases from the pores of the material and to remove any residue of the PFC coating from the mold that may be present on the final material. Calcination may also be used to reduce or eliminate hydrophobicity and make the slabs stronger.

The use of the synthesis scheme of small silica or other oxide nanoparticles as building blocks helps (i) to avoid large shrinkage during aging and drying and (ii) to ensure that the mesopores created between the nanoparticles were much smaller than the wavelength of visible light so as to minimize light scattering. Nanoparticle-based gels were found to experience smaller shrinkage than typical gels synthesized from molecular precursors (e.g., TEOS) because (a) virtually all of the silica is bound in the building blocks rather than dissolved in the solution and (b) there is little room for structural rearrangement and evolution once the network has formed. Most importantly, reactions of residual precursor and unreacted groups that drive shrinkage of typical gels are mostly absent in the nanoparticle-based gels. Conveniently, the reduced shrinkage of nanoparticle-based gels also enables large porosity.

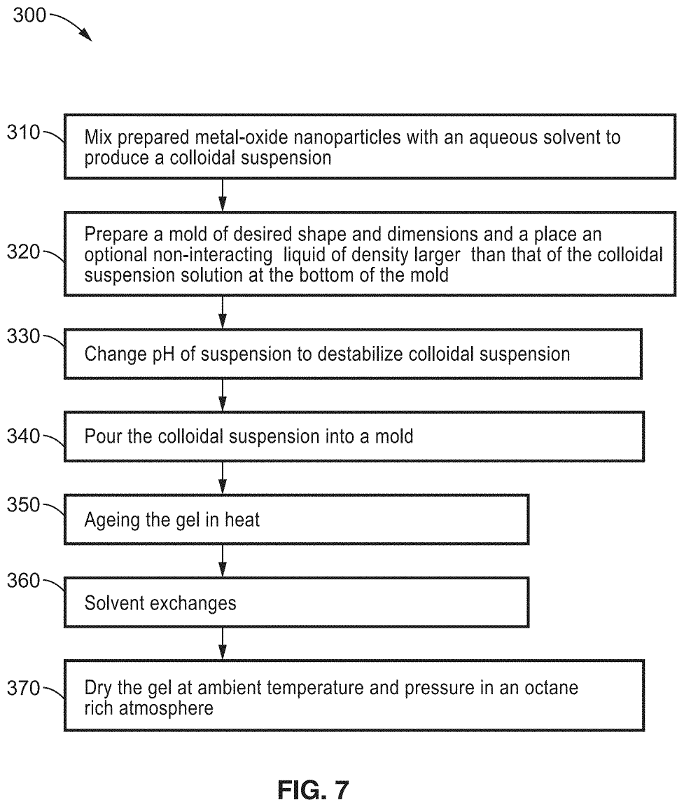

A variation of the embodiment of the synthesis methods of FIG. 6 is shown schematically in FIG. 7. In this hydrothermal variation 300, hollow, core-shell or solid metal oxide nanoparticles are prepared, preferably with particle diameters of less than or equal to about 20 nm. The nanoparticles are mixed with one or more aqueous solvents to produce a colloidal suspension at block 310 of FIG. 7.

The concentration of metal oxide (SiOx) nanoparticles in the solution at block 310 can be adjusted to control (i) the volume fraction of water in the gel, (ii) the mechanical stability of the gel, and (iii) the porosity of the final mesoporous silica slab. The gel can be hydrothermally treated (i.e., heated in aqueous solution at temperature below the boiling temperature) before the drying process to induce a succession of silica dissolution and precipitation processes that (a) changes porosity and pore size of the final mesoporous silica slab and (b) strengthens the mechanical stability of the gel. This enables the gel to dry faster thanks to its improved strength and tolerance to capillary pressure in pores.

Moreover, nanoparticles made of materials other than silica can be added to the colloidal suspension of block 310 of the synthesis method to manufacture composite porous slabs. In some cases, composite porous slabs can achieve lower effective thermal conductivity than porous silica slabs with the same porosity, while maintaining high transmittance and low haze. Examples of composite nanoparticle-based slabs with lower effective thermal conductivity include porous silica-titania slabs and porous silica-zirconia slabs due to the mismatch in phonon or energy carrier(s) vibration spectra between adjacent particles.

The mold is prepared at block 320 to receive the assembled colloidal suspension of block 310. Materials with square, rectangular or other shapes can also be obtained by using molds with different shapes at block 320. In addition, curved substrates or molds can be used to manufacture non-flat porous slabs with complex shapes. Thicker or thinner casts can be prepared by adjusting the volume of colloidal solution. The porosity can be further increased by addition of a template to the colloidal solution that can be subsequently removed by calcination, chemical reaction, or other means. Examples of templates include micelles of block copolymers or other surfactants (e.g., Pluronic P123, Pluronic F127, cetyltrimethylammonium bromide), organic nanoparticles (e.g., made of poly(methyl methacrylate) (PMMA)), and inorganic nanoparticles (e.g., carbon, ZnO), for example.

An optional coating of the mold may also be provided at block 320. The perfluorocarbon liquid coating reduces adhesion and enables the gels to shrink freely during aging and drying without incurring significant stress that could cause fracture.

The colloidal suspension of silica nanoparticles can then be destabilized and gelled by adjusting its pH at block 330. The destabilized colloidal suspension is then cast into the prepared mold at block 340 and allowed to gel in this embodiment.

Colloidal suspensions of silica nanoparticles are typically stable only in very acidic or very basic solutions. Thus, adjusting pH of the cast colloidal suspension of silica nanoparticles to between pH 2 and pH 8 destabilizes the suspension (the exact pH values may depend on the size, concentration and composition of the silica nanoparticles in the colloidal suspension). As a result, (i) the colloidal silica solution will gel within hours instead of days and (ii) most of the water is retained. Because the gel contains a high-volume fraction of water, the resulting mesoporous nanoparticle-based silica slab has high porosity once the water is removed from the structure.

The cast gel is then aged at temperatures above ambient temperature, preferably between approximately 40° C. to approximately 80° C., at block 350 over a period of time. Aging typically ranges from 1 to 14 days at block 350.

After aging at block 350, the aged gel can be removed from the mold and the aqueous solution filling the pores can be preferably be exchanged at block 360 of FIG. 7 one or more times with different organic solvents.

The aged gel is then dried slowly at ambient temperature and pressure at block 370 of FIG. 7 to remove any latent solvents and to minimize any shrinking or cracking. In one embodiment, the drying takes place in an octane rich atmosphere.

The high optical transparency is achieved in part from (i) the use of metal-oxide nanoparticles with diameter <20 nm, (ii) pore width <20 nm, and (iii) the use of PFC liquid to decrease roughness of the bottom surface, all of which reduce the visible light scattering. The low thermal conductivity is the result of the large porosity. The porous metal oxide slabs are significantly more thermally resistive than silica glass (i.e., the thermal conductivity of the porous SiO₂ slab is significantly less than silica glass or soda-lime-glass used in windows.

The cast may also be polished using a cork belt, or similar polishing equipment, to eliminate the surface roughness and lower the haze. The cast can also be cut using a diamond saw, or similar cutting equipment, to achieve the desired shape.

Finally, the slabs can be surface modified with a chemical such as trimethylchlorosilane (TMCS) to impart additional surface hydrophobicity. A refractive-index-matched adhesive can be applied to the cast to lower the haze due to surface roughness. In addition, a refractive-index-matched adhesive can be used to affix the cast to other objects in a fashion that preserves optical clarity. A low-emissivity (low-e) coating can be applied to the cast to minimize thermal radiation.

The technology described herein may be better understood with reference to the accompanying examples, which are intended for purposes of illustration only and should not be construed as in any sense limiting the scope of the technology described herein as defined in the claims appended hereto.

### EXAMPLE 1

To demonstrate the operational principles of the thermal barrier materials and methods, ambigels were produced using the sol-gel methods outlined in FIG. 5 as free-standing slabs and silica aerogels were also prepared for comparison. Generally, an acid catalyzed tetraethoxysilane (TEOS) based sol and a two-step acid-based TEOS/ methyltriethoxysilane (MTES) sol were used to form gels that were dried with nonpolar solvents at ambient temperature and pressure. It was found that ambiently dried silica ambigels can achieve a smaller and narrower pore size distribution resulting in larger visible transmittance and smaller thermal conductivity and haze compared to a supercritically dried silica aerogel of similar porosity and thickness.

TEOS and methyl modified TEOS mesoporous silica ambigel slabs with approximately 0.5 mm in thickness with porosity between 50% and 75% and narrow pore size distribution under 15 nm were synthesized through ambient drying in a nonpolar solvent. First, a sol of tetraethyoxysilane (TEOS) [Sigma-Aldrich], DI water, ethanol, formamide [Sigma-Aldrich] and concentrated HCI [Sigma-Aldrich] added dropwise was produced and stirred for 2 h at room temperature to promote hydrolysis. The molar ratio of H₂O:HCl was kept constant at 4:3.8×10⁻². Representative molar ratios of TEOS:H₂O:ethanol:formamide are found in Table 1.

A second set of ambigel recipes were prepared in the same manner but utilized methyltriethoxysilane (MTES) [Sigma-Aldrich] as a co-precursor with TEOS and was both acid and base catalyzed to reduce the gelation time. After the concentrated. HCl was added as described above, 2M NH₄OH was added at a volume ratio of 6 mL base to 17 mL sol and the resulting mixture was stirred for 2 h. The molar ratios of MTES:TEOS:H₂O:ethanol:formamide solutions are also outlined in Table 1.

After stirring, the liquid sols were cast into a 10 mm×10 mm×1 mm plastic cassette where they gelled overnight and were aged for approximately 1 week. They were then removed from the cassettes and submerged in ethanol to wash the pores of all other solvents. Next, an acetone exchange was repeated four times in 24 h. The acetone was either exchanged with cyclohexane, four times in 24 h, to form the TEOS silica ambigels or n-heptane to form the MM-TEOS silica ambigels. Ambigels were dried at ambient temperature and pressure by draining the solvent and allowing slow evaporation of the pore solvent in a sealed container over ˜1 week. Ambigels were heat treated at 500° C. for 24 h (TEOS) or 5 h (MM-TEOS) at a ramp rate of 1° C. min⁻¹ to remove any residual solvent and unreacted precursors. These times and temperature were determined from thermogravimetric analysis on previously made samples of the same composition. A uniform ˜3% volume reduction in size was observed after heat-treatment. Five TEOS1, two MM-TEOS1, and two MM-TEOS2 ambigels were synthesized to verify repeatability of the processes.

The addition of formamide, a polar, protic solvent, in the sol enabled the stabilization of [Si(OR)ₓ(OH)_{y}]n by promoting crosslinking of the silica network through hydrogen bridging. This resulted in a more uniform pore size distribution, a stronger network, and faster gelation times due to increased gel nucleation rates. Although ambient drying with nonpolar solvents reduces capillary pressure in the gel, the pore wall pressure is not absent, as in supercritical drying. This implies the need for a balance between strength and pliability in the pore network to resist collapse due to shrinkage yet allow for shrinkage without shattering. The extent of crosslinking in the formamide modified TEOS ambigels achieved this balance, resulting in an overall volume reduction in excess of 30% upon ambient drying without cracking in the ˜4 cm wide×˜5 cm long×˜0.06 cm thick gel.

Structural characterization and evaluation of the optical properties and thermal properties of the various ambigels and the aerogel were also performed. Variations in drying processes and precursor recipes produced structural differences in porosity, pore size, and surface chemistry.

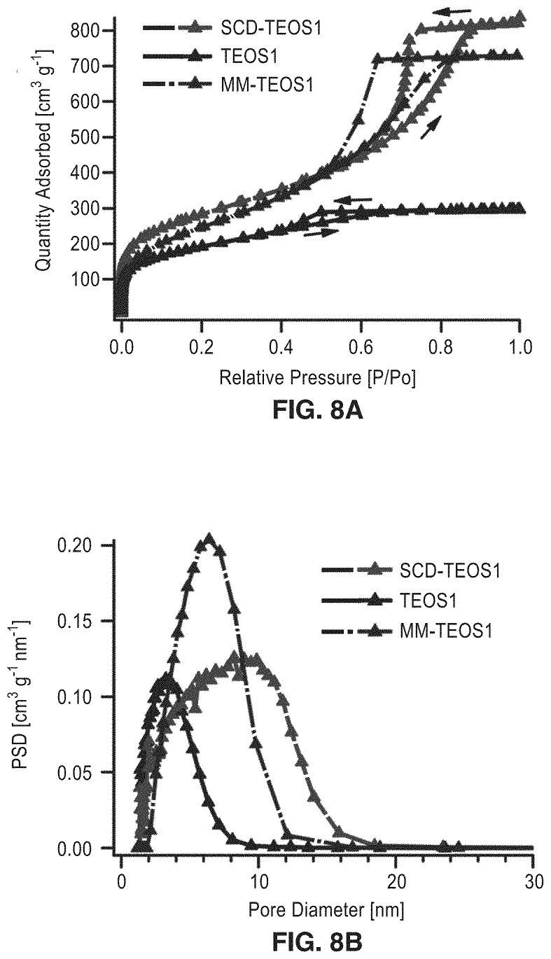

The N₂ porosimetry adsorption isotherms and the corresponding pore size distributions for silica aerogel and ambigel samples are shown in FIG. 8A and FIG. 8B. The TEOS and TEOS/MTES silica ambigel methods avoid total pore collapse and representative samples achieve a pore size distribution less than 15 nm while retaining 51 vol. % and 73 vol. % open porosity, respectively. As predicted, the MM-TEOS1 ambigel isotherm displayed only mesopores. However, after drying in n-heptane, all mesopores were small enough to limit visible light scattering. The methyl groups on the surface of the methyl-modified structure enabled the gel to form larger pores in the wet state and to resist further crosslinking upon drying.

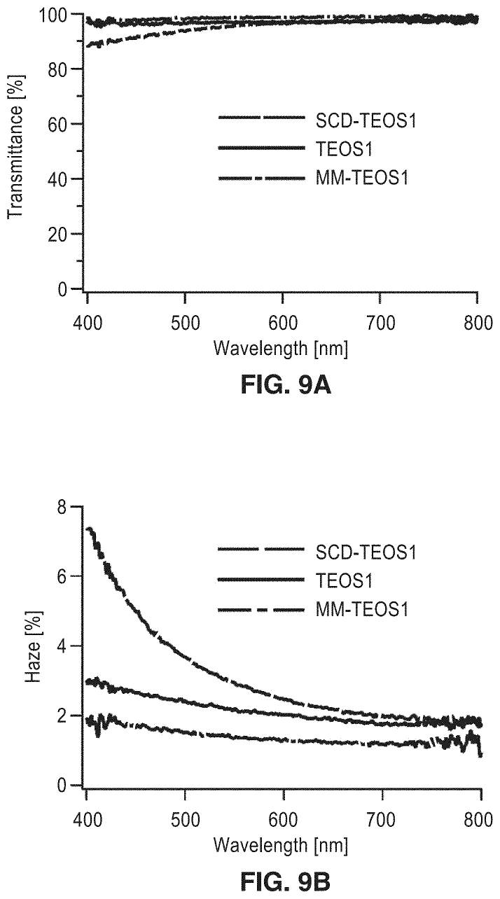

The ambigels featured excellent optical clarity across the entire visible spectrum with transmittance >95% and haze <3.1% for a 0.6 mm thick slab as illustrated in FIG. 9A and FIG. 9B respectively.

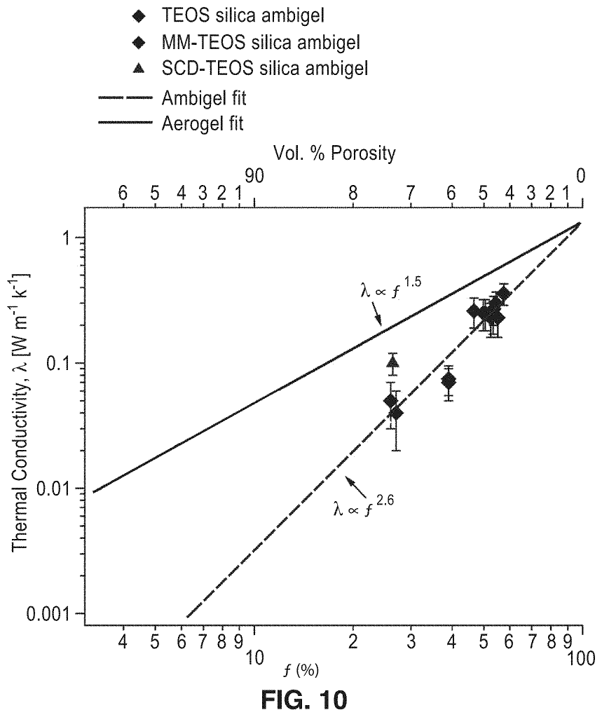

Thermal conductivity of the TEOS silica ambigels, measured by time domain thermo-reflectance (TDTR), was measured at 0.26±0.07 W m⁻¹ K⁻¹ and 0.04±0.02 W m⁻¹ K⁻¹, respectively. Thermal conductivity as a function of solid vol. % for SCD-TEOS1 aerogel, TEOS ambigels and MM-TEOS ambigels is shown in FIG. 10.

By tailoring the synthesis chemistry as well as the drying conditions, the pore size and porosity were controlled to simultaneously reduce visible light scattering by pores and increase the phonon scattering rate, producing aesthetically pleasing, thermally insulating, and cost-effective coatings for windows or glass panels. The simple recipes presented can be further optimized by adjusting solvent ratios and/or pre- or post-treatments that induce hydrophobicity with the goal of further increasing the porosity. Overall, the shrinkage involved in ambient drying, which eliminated the need for expensive supercritical drying, was exploited to obtain a sub-15 nm pore size distribution that minimized light scattering in the visible part of the spectrum while simultaneously reducing thermal conductivity.

By comparison, a supercritically dried TEOS silica aerogel with similar porosity to the TEOS/MTES silica ambigel is presented (73 vol. %). The TEOS silica aerogel is less thermally insulating with a thermal conductivity of 0.10±0.02 W m⁻¹ K⁻¹. It is also less transparent (transmittance <90% and haze >7% at blue wavelengths) than the TEOS/MTES silica ambigel. Thus, ambient drying enables control of pore size which can be used to tune optical transmittance and thermal transport for any given porosity.

### Example 2

To further demonstrate the functionality of the system and methods, silica ambigels were synthesized using sol recipes based on acid-catalyzed tetraethyoxysilane (TEOS) and a combination of methyltriethoxysilane (MTES) and TEOS precursors as described in Example 1. TEOS/MTES ambigels were also synthesized with post gelation surface treatment of trimethylchlorosilane (TMCS), phenyltrichlorosilane (PTCS), or triethylchlorosilane (TECS). These surface treatments were used to create higher porosity ambigel structures albeit with larger pores. In addition to achieving excellent optical transparency and low thermal conductivity of synthesized gels, a comparison of gels with varying pore size and porosity provides insight into engineering porous insulation materials to more efficiently utilize a given porosity. The mesoporous structure of silica ambigel slabs and the resulting optical and thermal properties suggest that small pore (<15 nm) ambigels may be ideal for transparent thermal insulation. This study demonstrates that ambiently dried silica aerogel monoliths, i.e., ambigels, can simultaneously achieve high optical transparency and low thermal conductivity, proving to be an ideal candidate for energy saving windows.

A combination of tetraethoxysilane (TEOS), methyltriethoxysilane (MTES) and post-gelation surface modification precursors were used to synthesize gels according to various sol-gel recipes. They were dried with nonpolar solvents under ambient conditions to form monoliths with 0.5 mm to 2.5 mm in thickness. Synthesis conditions were controlled such that silica monoliths can achieve a narrow pore size distribution, <15 nm, which leads to transmittance >97% and haze <2%. Notably, the effective thermal conductivity of TEOS/MTES and surface-modified TEOS/MTES ambigels were similar and equal to 0.04 W m⁻¹ K⁻¹, despite their different porosities of 74% and 81%, respectively.

Post-gelation surface treated ambigels started with the same procedure as described for MTES:TEOS samples. Initially the MTES:TEOS was mixed and allowed to gel. Then, the gel was submerged in an ethanol bath for 30 minutes followed by a heptane wash for 30 minutes. Then, the gel was treated with surface modifying solutions of chlorosilanes namely (i) 0.5 vol. % trimethylchlorosilane (TMCS), (ii) 2.0 vol. % phenyldimethylchlorosilane (PhCS), or (iii) 2.0 vol. % triethylchlorosilane (TECS) in n-heptane, for 30 min followed by a 30 min ethanol wash. The surface modifying treatment was repeated twice. Finally, the gel was rewashed in pure n-heptane and then allowed to dry ambiently in an n-heptane rich atmosphere. No post processing heat treatment was performed.

The morphology, structure and the optical and thermal properties of the various ambigel structures were then characterized. The sol-gel synthesis method that was employed produced gels of varying morphology depending on the specified sol composition, surface treatment, and drying method.

Despite variations in preparation procedures, all synthesized silica ambigels and aerogels were mesoporous free-standing slabs. The size of the final slabs was determined by (a) the size of the molds used for gelation and (b) the degree of shrinkage during the aging and drying stages. Thus, the size of the slabs can be readily scaled up by using larger molds. Calcination times and temperature were determined from thermogravimetric analysis on previously made samples of the same composition. In all ambigels which undergo heat-treatment, an isotropic (˜3%) volume reduction in size was observed after heat-treatment.

Although ambient drying with nonpolar solvents can significantly reduce the capillary pressure exerted by the solvent on the pore walls, forming ambigels does not completely eliminate capillary forces and gel shrinkage. As a result, synthesis of large, crack-free mesoporous silica slabs is very challenging. Formamide, was used to strengthen the silica framework during the aging and drying stages. When added to silica sol, formamide stabilizes [Si(OR)ₓ(OH)_{y}]n units by hydrogen bonding and promotes crosslinking by acting as a base. This is due the hydrolysis of formamide into NH₃ and formic acid, which increases the pH of the sol and, in turn, increases the rate of condensation. As a result, gelation occurred faster and the resulting silica gel was stronger due to increased gel crosslinking. The as synthesized mesoporous ambigel slabs were able to withstand as much as 30% volume shrinkage during the ambient drying process without cracking. This combination of (i) ambient drying with nonpolar solvents and (ii) network strengthening with formamide was a key to synthesizing the large crack-free mesoporous silica slabs.

The selected sol composition and drying technique also had clear effect on the pore structure. The MTES:TEOS1 ambigel was prepared and dried similarly to the TEOS1 ambigel but, because of incorporation of methyl groups from the MTES precursor, the MTES:TEOS1 ambigel exhibited higher porosity (74% vs. 51%) after drying and calcination. Post-gelation surface modification of MTES:TEOS1 with 0.5 vol. % TMCS resulted in a gel having increased methyl concentration and an even higher porosity (81%). This increase in porosity with increasing methyl concentration can be attributed to the so-called “spring back effect” observed in organically-modified mesoporous silica. The spring back is a result of a smaller number of reactive hydroxyl groups on the silica gel's surface due to substitution of hydroxyl groups by the organic groups. As a result, there are fewer hydroxyl groups to form new Si—O—Si bonds that would otherwise stiffen the organically-modified gel when it undergoes shrinkage.

The effects of the spring back effect also manifested themselves in the pore size distribution (PSDs). The average pore size taken from the PSD increased with increasing methyl content as TEOS1, MTES:TEOS1, and MTES:TEOS1:0.5TMCS had an average pore size of 3.3, 6.4, and 8.2 nm, respectively. This highlights the ability of the organically-modified gels to expand after the initial shrinkage and illustrates that gels with higher degrees of surface modification can expand further. Here, it was assumed that all ambigels experienced a similar degree of shrinkage since the preparation and drying were similar for all samples.

The ambigels with relatively small and narrow pore size distributions, 1 nm to 15 nm were shown to provide excellent materials for visible light transmission. As commonly seen in blue tinted and opaque aerogel specimens, pores greater than 15 nm to 20 nm in diameter cause larger haze at shorter wavelengths due to Rayleigh scattering. The MTES:TEOS1:0.5TMCS ambigel demonstrated this phenomenon with decreasing transmittance and increasing haze to 4.1% at wavelengths in the lower end of visible spectrum, giving a slightly blue tint. On the other hand, the TEOS1 and MTES:TEOS1 silica ambigel samples displayed transmittance greater than 95% and haze below 3.1% and 2.0% throughout the visible spectrum. This good optical clarity can be attributed to the small and narrow pore size distribution in both samples, where all pores are less than 15 nm. Previous studies on ambiently dried monolithic silica reported visible transmittance less than 80%, which leads to relatively poor quality of an observed image.

Thin film ambigels dried in n-hexane obtained through dip- and spin-coating processes on glass slides were shown to display excellent optical properties (˜90% transmittance in the visible range at 80 vol. % porosity).

The effective thermal conductivity k_{eff} of the aerogel and ambigel samples were measured either by the TDTR method at room temperature under vacuum or by the guarded hot place method at room temperature in ambient air. To provide context for the practical application of these silica ambigels for windows, the U-value of a single-pane window and a single-pane window plus ambigel system of the same thickness was calculated. The 3.0 mm single-pane window plus 2.5 mm MTES:TEOS1:THK ambigel system gives a 20% reduction in center-of-glass U-value compared a traditional glass 5.5 mm single-pane window.

Traditional silica aerogel studies led with the assumption that increasing porosity is the central method for reaching low thermal conductivities as long as porosity remains below 95%, where radiative effects begin to dominate. The fact that the thermal conductivity of the MTES:TEOS1 and MTES:TEOS1:0.5TMCS ambigel samples were similar, despite having significantly different porosities, was unexpected.

Extrapolating the small-pore ambigel fit to lower vol. % silica suggests that if ambigels with larger porosity can be synthesized while maintaining the small pore size and narrow pore size distribution <15 nm, the thermal conductivity will be even lower than that obtained for aerogels. At just about 10 vol. % of silica (i.e., porosity of 90%), an ambigel with pore size under 15 nm could achieve a thermal conductivity in vacuum lower than the current range for high performance silica aerogel insulation products, i.e. approximately 0.010 W m⁻¹ K⁻¹, while exhibiting exceptionally high transparency. This indicates that silica gels with small pore sizes exhibit significantly lower effective thermal conductivity than traditional supercritically dried aerogels featuring a large pore size. Thus, for fractal materials, a larger fractal dimension is desired in order to achieve a lower thermal conductivity for a given porosity.

Additionally, for energy saving window applications wherein the structural integrity of the material is important, gaining thermal resistance with less porosity by using small pores can improve the development and implementation of ambigel materials on an industrial scale.

### Example 3

To further demonstrate the operational principles of the materials and methods, a template-free water-based sol-gel method to synthesize thick transparent and thermally insulating mesoporous silica monolithic slabs by gelation and drying of a colloidal suspension of silica nanoparticles under ambient conditions were performed as generally outlined in FIG. 6.

Mesoporous silica slabs were synthesized on perfluorocarbon liquid substrates to reduce adhesion and to enable the gels to shrink freely during aging and drying without incurring significant stress that could cause fracture. The free-standing nanoparticle-based mesoporous silica slabs were disks or squares, with thickness between 1 mm and 6 mm, and porosity of around 50%. The slabs had high transmittance and low haze in the visible spectrum due to small nanoparticles (6 nm to 12 nm) and pore size (<10 nm), narrow pore size distribution, and optically smooth surfaces (roughness <15 nm). The slabs' effective thermal conductivity of 104 to 160 mW m⁻¹ K⁻¹ at room temperature was smaller than that of other mesoporous silicas with similar or even larger porosity reported in the literature. This was attributed to the fractal structure and high mass fractal dimension of the slabs. The mechanical properties of the slab were similar to those of common polymers. The simple synthesis is readily scalable and offer promising materials for window solutions and solar-thermal energy conversion, for example.

Synthesis of mesoporous silica monolithic slabs used a PFC liquid substrate to minimize adhesion between the gel and the substrates and to obtain optically smooth surfaces. The PFC liquids were selected as substrates because of (i) their omniphobic properties, ensuring immiscibility with the aqueous colloidal solution of silica nanoparticles, (ii) their high density, ensuring that the colloidal solution floated on the liquid substrate, and (iii) large surface tension with water, ensuring flatness of the liquid-liquid interface. The latter enabled the gels to shrink during aging and drying without incurring significant stress that would otherwise lead to fractures. Similar effects were achieved using the PTFE substrate due to its non-stick properties, but the surface roughness of the PTFE was much greater. Moreover, despite its high chemical inertness, gels still slightly adhered to the PTFE substrate, resulting in lower yield of crack-free slabs. Note that this effect was negligible for slabs with a small footprint surface area (<3 cm in diameter). However, larger slabs cracked noticeably more often during aging. By contrast, slabs prepared on PFC liquids did not crack during aging regardless of their size.

In addition, the present synthesis used small silica nanoparticles (6 nm to 12 nm in diameter) as the building blocks (i) to avoid large shrinkage during aging and drying and (ii) to ensure that the mesopores created between the nanoparticles were much smaller than the wavelength of visible light so as to minimize light scattering. Nanoparticle-based gels experienced smaller shrinkage than typical gels synthesized from molecular precursors (e.g., TEOS) because (a) virtually all silica is bound in the building blocks rather than dissolved in the solution and (b) there was little room for structural rearrangement and evolution once the network had formed.²⁵ Most importantly, reactions of residual precursor and unreacted groups that drive shrinkage of typical gels are mostly absent in our nanoparticle-based gels. Conveniently, the reduced shrinkage of nanoparticle-based gels also enabled us to achieve large porosity.

Overall, mesoporous silica monolithic slabs with sizes between 2 cm and 4.5 cm and thickness between 1 mm and 6 mm were synthesized. While the final size and shape of the slabs were determined by those of the mold, the average thickness was determined by the initial volume of the colloidal solution of silica nanoparticles. Notably, the PFC substrate (SiO₂-PFC-rt) slabs had higher transparency than the mold surface only (SiO₂-PTFE-rt) slabs.

The nanoparticle-based mesoporous silica slabs formed on PFC were synthesized as follows: a) between 5 mL and 30 mL of the colloidal solution of silica nanoparticles was placed in a PTFE mold with PFC liquid (either Krytox GLP 100, GPL 104 or GLP 106) covering the bottom surface in a 1 mm to 3 mm thick layer; b) Water was slowly removed by evaporation resulting in gelation and aging of nanoparticle-based slabs in the shape of the mold; and c) The slabs were then slowly dried to remove all water without cracking leading to mesoporous silica slabs. The drying rate was controlled via (i) the mold's opening size, (ii) temperature, and (iii) surrounding relative humidity. Here, the samples were dried either (i) in ambient air at room temperature or in a convection oven at 25° C., with a mold's opening corresponding to 0% to 10% of the mold surface area, (ii) in a convection oven at 40° C. with a mold's opening completely covered, or (iii) in a humidity chamber at room temperature and relative humidity of 50% to 80%. The resulting mesoporous silica slabs were calcined in oxygen at 400° C. for 2 h using a 5° C. min⁻¹ temperature ramp to remove any NH₃ and PFC residues.

Surface roughness of the two faces of nanoparticle-based mesoporous SiO₂-PFC and SiO₂-PTFE slabs were evaluated, along with that of commercial float glass obtained from Nippon Sheet Glass (Japan), used as a reference. Surface roughness can be a major source of scattering and is an indicator of clarity.

While the top surface of the SiO₂-PTFE slabs was optically smooth (Rₐ=4.5±0.2 nm), the bottom surface, which was in contact with the PTFE mold, had a much higher roughness of Rₐ=140±9 nm that is comparable to the wavelength of visible light. The observed roughness was caused by the roughness of the PTFE substrate imprinted onto the slab's bottom surface during gel formation. In comparison, both the top and bottom surfaces of the SiO₂-PFC slabs were optically smooth with surface roughness between 13.4 nm and 15.5 nm. In fact, the surface in contact with the PFC liquid substrate was as smooth as the top surface. As a reference, soda-lime sheet glass had a surface roughness ten times smaller than that of the mesoporous SiO₂-PFC slabs (Rₐ=1.6±0.1 nm) resulting from the float glass process on liquid tin.

Another challenge for the SiO₂-PTFE slabs is that scratches and defects in the PTFE substrate resulted in the formation of air bubbles at the bottom surface of some SiO₂-PTFE slabs. The scratches and defects acted as nucleation sites for the formation of bubbles from gases dissolved in the colloidal solution. These bubbles strongly scattered light due to their large diameter, ranging between 0.1 mm and 1 mm. Both surface roughness and bubble nucleation were minimized either when PTFE molds with extremely smooth surfaces were used or for all slabs synthesized on PFC liquid substrates.

Accordingly, the PFC liquid was shown to be a suitable substrate (1) to reduce adhesion between gel and substrate, enabling the gels to shrink freely during aging and drying without incurring significant stress that would otherwise lead to fractures, and (2) to provide a smooth interface that results in slabs with optically smooth surfaces.

The free-standing nanoparticle-based mesoporous silica slabs had a porosity between about 45% and 55%. The slabs had high normal-hemispherical transmittance (>85%) and low haze (<5%) in the visible region of the spectrum due to small nanoparticle size, small pore size, narrow pore size distribution, and optically smooth surfaces, all of which resulted in limited volumetric and surface light scattering. The lowest effective thermal conductivity achieved was 104±15 mW m⁻¹ K⁻¹ and the mechanical properties are superior to common polymers such as PVC and PMMA.

Most notable, however, is the fact that the slabs had an effective thermal conductivity smaller than those reported in the literature for other mesoporous silica materials with similar or larger porosity. This was attributed to the fractal structure and the high mass fractal dimension of the slabs synthesized in this study, as established by small-angle X-ray scattering.

### Example 4

In another demonstration of the operational principles of the methods and materials, transparent and thermally insulating large and thick mesoporous nanoparticle-based silica slabs were prepared using the hydrothermal treatment method generally outlined in FIG. 7. The hydrothermal treatment strengthens the silica network before it is subjected to solvent exchange and drying, producing large, crack-free slabs with high porosity. During hydrothermal treatment, silica slowly dissolves from the thick parts and precipitates in the thin parts of the framework due to Ostwald ripening. This process strengthens the framework resulting in: (i) less shrinkage during solvent exchange, (ii) larger porosity, and (iii) less cracking.

In this illustration, 5 mL to 120 mL of a colloidal solution of silica nanoparticles (Nalco 2326, 15 wt. % in water, NH₃ stabilized, 9 nm±3 nm in diameter) was adjusted to pH 5 to pH 9 with hydrochloric acid to destabilize the colloidal suspension. The destabilized solution was then sealed in a PTFE mold with the bottom covered in 2 mm to 3 mm thick layer of perfluorocarbon liquid, transferred to an oven, and allowed to gel and to age at 40-80° C. over the period of 1 to 14 days.

Thereafter, the PTFE mold with the gel inside was cooled to room temperature and unsealed. The gel was removed from the mold and the aqueous solution filling the pores was exchanged multiple times with different organic solvents. The optimized order of solvents exchange was: (i) 50/50 vol%/vol% of water and ethanol, (ii) ethanol, (iii), ethanol, (iv) 50/50 vol%/vol% ethanol and acetone, (v) acetone, (vi) acetone, (vii) 50/50 vol%/vol% acetone and octane, (viii) octane, and (ix) octane. After the last exchange with octane, the gel was slowly dried at ambient pressure and temperature in an octane-rich atmosphere to minimize the gel's shrinkage and cracking.

The synthesized mesoporous nanoparticle-based silica slabs had a diameter d=4″, thickness t=5 mm. The slabs had a porosity of φ=80% as measured using nitrogen porosimetry. This corresponded to an estimated effective thermal conductivity of k_{eff}=0.35 W/mK.

For a window solution, the coating material had a U-value=0.46 BTU/ft²/° F./hr, and condensation temperature Tc=−6.5° C. These results show that optimization of hydrothermal treatment was crucial in synthesizing large, thick, and crack-free mesoporous slabs with high porosity and low effective thermal conductivity. Here, the mild hydrothermal treatment at 50° C. minimized the stresses due to gradients and avoided microcracks formation resulting in a large, thick, and crack-free mesoporous slab with high porosity and low effective thermal conductivity.

### Example 5

Different types of low-conductivity nanoparticle building blocks for use in the various synthesis schemes was evaluated. The nanoparticle building blocks were designed (i) to be a drop-in replacement for silica nanoparticles in the synthesis of mesoporous nanoparticle-based silica slabs and (ii) to reduce the effective thermal conductivity of the slab.

In one embodiment, core-shell nanoparticles made of a heavy-atom metal oxide (e.g., CeO₂) core were synthesized and evaluated. The latter composition was based on the positive results obtained for mesoporous sol-gel SiO₂/TiO₂ films that demonstrated that incorporation of heteroatoms into mesoporous silica increased phonon scattering resulting in lower effective thermal conductivity.

Notably, the core-shell structure by design ensures uniform distribution of CeO₂ scattering sites through mesoporous structure. The chemistry and behavior of colloidal solutions of CeO₂—SiO₂ core-shell nanoparticles were expected to be very similar to that of colloidal solutions of silica nanoparticles because the outer shell of CeO₂—SiO₂ core-shell nanoparticles that defines their chemical properties is made of silica.

In a second embodiment, hollow shelled silica nanoparticles were synthesized and evaluated as building blocks to add scattering centers and additional porosity to mesoporous nanoparticle-based silica slabs.

To demonstrate core-shell nanoparticle synthesis, CeO₂—SiO₂ core-shell nanoparticles were synthesized using a water-in-oil microemulsion method. Specifically, 0.4 mL of 0.14 M aqueous CeCl₃ and 0.3 mL of 1 M aqueous oxalic acid were injected into a solution of 3.41 g of Brij C10 (polyethylene glycol hexadecyl ether) in 10 mL of cyclohexane. Subsequently, 2.04 mL to 1.5 mL of tetraethyl orthosilicate (TEOS) followed by 0.45 mL to 0.61 mL of 2.7 M aqueous NH4OH were injected to the same solution that was then stirred at 50° C. for 60 min. The amounts of TEOS and NH₄OH solution were varied to adjust the silica shell thickness. The solution was then centrifuged for 20 min and the separated CeO₂-SiO₂ core-shell nanoparticles were resuspended in cyclohexane; this was repeated twice. Then, the procedure was repeated again but the nanoparticles were resuspended in 2-propanol instead of cyclohexane; this was repeated twice as well. The solution of nanoparticles suspended in 2-propanol was then dried in a humidity chamber at relative humidity above 50%, calcined in oxygen at 350° C. for 6 h, then resuspended in ethanol or water for characterization.

Nanoparticles with core diameters of d=4 nm to 5 nm, shell thicknesses t=10 nm, and total diameter of about d=25 nm were produced. The synthesized CeO₂—SiO₂ core-shell nanoparticles strongly scattered visible light due to their size, i.e., d>20 nm. Therefore, future particles and coated particles with other heavy-atom metal oxide cores should have a final diameter of less than 20 nm.

Hollow silica shells were synthesized using a single micelle templating technique and evaluated. Specifically, 1.0 g of triblock copolymer Pluronic F108 (EO132PO50EO132) was dissolved in 30 mL of 2 M HCl by stirring for 1 h. Thereafter, 1.4 mL of xylene was added, and the solution was stirred for 2 h and then 1.5 mL of TEOS was added dropwise and the solution was stirred for 24 h. Finally, the solution was concentrated using an ultrafiltration technique without exchanging the solvent.

Mesoporous hollow shell-based silica powders were made by drying the concentrated solution in a Petri dish at 90° C. and subsequent calcination in oxygen at 350° C. for 6 h. Mesoporous hollow shell-based silica films were made by spin coating the concentrated solution on p-doped Si substrates and subsequent calcination in air at 350° C. for 6 h.

TEM imaging of hollow silica shells with diameters d=18±1 nm and shell thickness t=3.5±1 nm. It established the successful preparation of hollow silica shells that can be used as building blocks for nanoparticle-based slabs.

Hollow shell nanoparticles can readily replace solid silica nanoparticles in the synthesis of nanoparticle-based slabs resulting in increased porosity and decreased effective thermal conductivity. Mesoporous hollow shell-based SiO₂ slabs were synthesized and evaluated. A colloidal solution of hollow shell SiO₂ nanoparticles was prepared. From 15 mL to 240 mL of the colloidal solution was poured into a PTFE mold and slowly dried at about 25° C. Afterwards the samples were calcined in oxygen at 450° C. for 4 h using a 1° C. per min heating ramp to remove organic compounds used in the synthesis of the hollow shell nanoparticles.

Mesoporous nanoparticle-based SiO₂ slabs using with dense silica nanoparticles were produced having a diameter d=2″ with a thickness of approximately =3 mm, porosity of φ=70% to 80%, and estimated effective thermal conductivity k_{eff}=0.039 W/mK.

Slabs using the hollow shell-based nanoparticle samples had porosity φ=67% to 76%, that was significantly larger than mesoporous nanoparticle-based SiO₂ slabs with φ=50% synthesized using the same method. The porosity increase was due to hollow cores of SiO₂ shells that contributed new porosity in addition to porosity created between silica nanoparticles. This is indicated in the observance of pore size distributions where a distinct peak at pore width w=12 nm to 18 nm was seen corresponding to the width of hollow cores while the remaining broad distribution corresponds to pores created between the nanoparticles. Notably, mesoporous nanoparticle-based silica slabs prepared by ambient drying (currently φ) =70% to 80%) should experience a similar porosity increase when hollow shell nanoparticles will be used in the synthesis.

SEM images of mesoporous hollow shell-based silica films made by spin coating of the colloidal solution of hollow silica shells without any block copolymer were also evaluated. The images show that (i) the films were made of randomly aggregated hollow silica shells with diameters d=20 nm or less, (ii) the thickness of silica shell was so thin that the SEM electron beam penetrated the silica shell partially reveling the hollow interior, and (iii) without block copolymer hollow silica shells formed films with cracks. Similar cracks were observed in mesoporous nanoparticle-based silica films prepared in the past using similar method, i.e., spin coating a colloidal solution without a structure directing agent. These cracks were due to high surface tension of water resulting in cracking due to strong capillary forces.

In contrast, mesoporous nanoparticle-based silica films prepared with block copolymers did not crack due to surface action of the block copolymers that lowered water surface tension. It is expected that using block copolymers will in the future will eliminate cracks in the mesoporous hollow shell-based silica films.

The mesoporous hollow shell-based silica film had a porosity φ=70% measured with optical reflectance and effective thermal conductivity k_{eff}=0.07±0.03 W/mK measured using TDTR in vacuum. Note that mesoporous hollow shell-based silica films, even without block copolymer, achieved larger porosity and lower effective thermal conductivity than any mesoporous sol-gel or nanoparticle-based silica film templated with block polymer. These results show that hollow silica shells have potential to lower effective thermal conductivity of mesoporous hollow shell-based silica slabs to less than 0.03 W/mK.

### Example 6

Temperature cycling durability tests were performed to demonstrate the durability of the slab and film materials. The effect of temperature cycling on optical and structural integrity of mesoporous ambigels and nanoparticle-based silica slabs was tested. The slabs were held (1) at 20° C. for 1.5 hours, (2) at 20° C. for 5 min, and (3) at 40° C. for 1.5 hours. These three steps were repeated 25 times for each sample and temperature profiles were acquired for the cycles of the test.

Optical images of mesoporous ambigel and nanoparticle-based silica slabs before and after 25 temperature cycles between −20° C. and 40° C. were observed. The images show that the structure and optical clarity of all slabs appeared unchanged after 25 cycles, i.e., no cracks, no haze, and no discoloration was observed. The results suggest that mesoporous ambigel and nanoparticle-based silica slabs will not change upon temperature fluctuations typically experienced by window products.

Temperature gradient durability tests were also performed. Schematic and optical images were taken of an apparatus developed to test glazing samples for 24 hours with an exterior temperature of −19° C., an interior temperature of 21° C., and a relative humidity of 30%. The glazing sample consisted of a mesoporous silica slab attached to a 3 mm thick square soda lime glass pane using crystal wax or optical adhesive. The apparatus consisted of a chiller that circulates silicon oil with temperature −19° C. through the base of a sample stage. The sample stage was machined from PMMA polymer and was designed to accommodate a glazing sample in a way that the glass bottom is exposed to silicon oil while the mesoporous silica slab glued on the top is exposed to room temperature and humidity, i.e., about 21° C. and about 30%, respectively.

Similarly, TEOS-MTES 11 ambigel slabs modified with 1 vol% of TMCS were evaluated by a temperature gradient durability test. Optical images demonstrated that the slabs did not crack or discolor after more than 24 hours exposed to a temperature gradient test between −40° C. and 21° C.

Accordingly, synthesis methods for manufacturing optically-clear and thermally-insulating nanoporous ambigel slabs and coatings are provided. Ambiently dried ambigels, offer a low-cost alternative to aerogels to obtain low density monoliths while retaining low thermal conductivity, high transmittance and low haze in the visible spectrum. Monolithic or coatings can be adapted to many applications where thin profile, thermal insulation is desired.

For example, an optically-clear, thermally-insulating porous slabs and coatings, with optional low-emissivity coating, can be applied directly to the outer side of a window, either before or after installation, with the help of an optically compatible adhesive, to increase the thermal resistance and reduce the heat losses. Alternatively, an optically-clear, thermally-insulating porous SiO₂ slab can be applied to one or more glass panes in a multiple-pane windows to increase the window's thermal resistance.

From the description herein, it will be appreciated that that the present disclosure encompasses multiple embodiments which include, but are not limited to, the following:

1. An optically clear thermal barrier, comprising: a mesoporous metal oxide monolithic slab with a thermal conductivity of 0.1 W/mK or less; an optical transmittance of 85% or greater, and a haze of less than or equal to 5% per 3 mm of slab thickness.

2. The barrier of any preceding or following embodiment, wherein the metal oxide is an oxide selected from the group consisting of silica, titania, zirconia, silica-titania and silica-zirconia.

3. The barrier of any preceding or following embodiment, further comprising: a transparent substrate coupled to the slab with a transparent adhesive.

4. The barrier of any preceding or following embodiment, wherein the mesoporous slab has an average pore size of less than 25 nm.

5. A thermally insulated transparent panel module, comprising: a planar transparent panel; and a thermal barrier comprising a mesoporous metal oxide monolithic slab with a thermal conductivity of 0.1 W/mK or less; an optical transmittance of 85% or greater and a haze of less than or equal to 5% per 3 mm of slab thickness coupled to the transparent panel.

6. The module of any preceding or following embodiment, further comprising a low-emissivity coating on the planar transparent panel.

7. The module of any preceding or following embodiment, further comprising a hard coating on the planar transparent panel to increase scratch resistance.

8. The module of any preceding or following embodiment, further comprising a transparent adhesive coupling the transparent panel and the thermal barrier together.

9. The module of any preceding or following embodiment, further comprising: a second planar transparent panel coupled to a second thermal barrier of a thermal conductivity of 0.1 W/mK or less; an optical transmittance of 85% or greater and a haze of less than or equal to 5% per 3 mm of slab thickness; and a frame orienting the second transparent panel substantially parallel to and spaced from the first panel and forming a sealed gap between panels.

10. The module of any preceding or following embodiment, wherein the thermal barrier of the first transparent panel and the thermal barrier of the second transparent panel face each other within the sealed gap.

11. The module of any preceding or following embodiment, further comprising: a dry inert gas selected from the group of nitrogen, argon, bromine, carbon disulfide, dichlorodifluoromethane and krypton sealed within the sealed gap between the first and second transparent panels.

12. The module of any preceding or following embodiment, further comprising: a second planar transparent panel with a low-emissivity coating on at least one side of the planar transparent panel; and a frame orienting the second transparent panel substantially parallel to and spaced from the first panel and forming a sealed gap between panels.

13. The module of any preceding or following embodiment, wherein the sealed gap encloses one or more of a vacuum, nitrogen gas, argon gas, bromine gas, carbon disulfide gas, dichlorodifluoromethane gas, krypton gas and air between the first and second transparent panels.

14. A method for fabricating an ambigel material, the method comprising: (a) combining one or more silica, titania or zirconia alkoxide precursors, an alcohol and water to produce a solution; (b) catalyzing the solution with an acid or base catalyst to form a gel; (c) aging the gel; (d) exchanging solvents in the aged gel with at least one nonpolar, low-surface-tension, high-vapor-pressure solvent to form an aged gel; (e) drying the aged gel at ambient temperature and pressure; and (f) heating the dry gel to remove any residual solvents to produce a final ambigel material.

15. The method of any preceding or following embodiment, further comprising: placing the solution into a mold to control final shape, thickness and curvature of the ambigel.

16. The method of any preceding or following embodiment, further comprising: placing a non-interacting liquid of density larger than that of the precursor solution at the bottom of the mold prior to pouring the solution; wherein interactions between the casted gel and an underling mold surface are minimized; and wherein roughness of the bottom surface of the mold is reduced.

17. The method of any preceding or following embodiment, wherein the non-interacting liquid comprises a liquid metal or a perfluorocarbon liquid.

18. The method of any preceding or following embodiment, wherein the solvent exchange comprises one or more exchanges of solvents selected from the group of solvents consisting of acetone, ethanol, n-hexane, n-pentane, heptane and cyclohexane.

19. The method of any preceding or following embodiment, the solution further comprising: a drying control chemical additive (DCCA).

20. The method of any preceding or following embodiment, wherein the drying control chemical additive (DCCA) comprises formamide.

21. The method of any preceding or following embodiment, further comprising: controlling the molar ratios of silane precursors, alcohol, water and formamide.

22. The method of any preceding or following embodiment, wherein the silica alkoxide precursor is a precursor selected from the group of precursors consisting of tetramethylorthosilane (TMOS), tetraethylorthosilane (TEOS), methyltriethoxysilane (MTES), methyltrimethoxysilane (MTMS), ethyltrimethyoxysilane (ETMS), and vinyltrimethoxysilane (VMTS).

23. The method of any preceding or following embodiment, the solution further comprising: coprecursors selected from the group consisting of hexamethyldisiloxane (HMDS), hexamethyl-disilazane (HMDZ) and polydimethylsiloxane (PDMS).

24. The method of any preceding or following embodiment, the solution further comprising: methyltriethoxysilane (MTES) as a coprecursor with TEOS.

25. The method of any preceding or following embodiment, further comprising: applying a surface modifying wash of a polar or nonpolar solvent to the gel after gelation and before or after aging.

26. The method of any preceding or following embodiment, wherein the modification comprises: replacing silica ambigel surface (OH) groups with an end group selected from the group consisting of a methyl group, a vinyl group, and a fluorine group.

27. The method of any preceding or following embodiment, wherein the gel surface (OH) groups are replaced with exposure to silane selected from the group consisting of a trimethylchlorosilane (TMCS), a phenyldimethylchlorosilane (PhCS), a triethylchlorosilane (TECS) or a fluorotriethoxysilane.

28. The method of any preceding or following embodiment, further comprising: drying the aged gel at a reduced pressure between 0 and 1 atmosphere and at a temperature above room temperature.

29. The method of any preceding or following embodiment, further comprising: drying the aged gel at a pressure below ambient pressure and at a temperature above ambient temperature and below a boiling point temperature of the last solvent used in the solvent exchange.

30. The method of any preceding or following embodiment, wherein the heating of the dry gel comprises calcining the gel to eliminate hydrophobicity and any remaining solvent residues.

31. A method for manufacturing optically-clear and thermally-insulating porous metal oxide slabs, the method comprising: (a) mixing metal oxide nanoparticles with an aqueous solvent to produce a colloidal solution; (b) pouring the colloidal solution into a mold of desired shape and dimensions; (c) evaporating off the solvent from the colloidal solution to form a gel; (d) ageing the gel; and (e) drying the gel to remove remaining solvent to produce a final optically-clear and thermally-insulating porous metal oxide slab.

32. The method of any preceding or following embodiment, further comprising: preparing metal oxide nanoparticles with diameters less than 20 nm, wherein the nanoparticles are smaller than the wavelength of visible light to minimize light scattering.

33. The method of any preceding or following embodiment, wherein the nanoparticles have an average diameter of less than 12 nm.

34. The method of any preceding or following embodiment, wherein the nanoparticles are selected from the group of nanoparticles consisting of hollow metal oxide nanoparticles, core-metal oxide shell nanoparticles and solid metal oxide nanoparticles.

35. The method of any preceding or following embodiment, further comprising: placing a non-interacting liquid of density larger than that of the colloidal solution at the bottom of the mold prior to pouring the colloidal solution; wherein interactions between the casted gel and an underling mold surface are minimized; and roughness of the bottom surface of the mold is reduced.

36. The method of any preceding or following embodiment, wherein the non-interacting liquid comprises a liquid metal or a perfluorocarbon liquid.

37. The method of any preceding or following embodiment, wherein the liquid metal is a liquid metal selected from the group consisting of mercury, gallium and low-melting point metal alloys.

38. The method of any preceding or following embodiment, wherein the perfluorocarbon liquid is a liquid selected from the group consisting of DuPont™ Krytox® oils and 3M™ Fluorinert™ liquids.

39. The method of any preceding or following embodiment, further comprising: destabilizing the colloidal suspension with an acid before pouring suspension into the mold; and aging the gel at a temperature above ambient temperature.

40. The method of any preceding or following embodiment, further comprising: removing the aged gel from the mold; and exchanging remaining aqueous solvents in gel pores with one or more organic solvents before drying the aged gel.

41. The method of any preceding or following embodiment, wherein the solvents exchanged are solvents selected from the group of solvents consisting of ethanol, acetone, octane and combinations thereof.

42. The method of any preceding or following embodiment, further comprising: applying a surface modifying wash of a polar or nonpolar solvent to the gel after gelation and before or after aging.

43. The method of any preceding or following embodiment, further comprising: drying the aged gel at a pressure below ambient pressure and at a temperature above ambient temperature and below a boiling point temperature of the last solvent used in the solvent exchange.

44. The method of any preceding or following embodiment, further comprising calcining the dried gel.

45. The method of any preceding or following embodiment, further comprising: controlling the concentration of nanoparticles in the original colloidal suspension; controlling temperature, relative humidity and gas flow environmental conditions during drying; and controlling the rate of drying to avoid cracking in the slabs.

46. A method for manufacturing optically-clear and thermally-insulating porous silica slabs, the method comprising: (a) mixing SiO₂ nanoparticles with an aqueous solvent to produce a colloidal solution; (b) pouring the colloidal solution into a mold of desired shape and dimensions; (c) evaporating off the solvent from the colloidal solution to form a gel; (d) ageing the gel; and (e) drying the gel to remove remaining solvent to produce a final optically-clear and thermally-insulating porous silica slab.

47. A method for fabricating an ambigel material, the method comprising: (a) combining one or more silica alkoxide precursors, an alcohol and water to produce a solution; (b) catalyzing the solution with an acid or base catalyst to form a gel; (c) aging the gel in a nonpolar, low-surface-tension, high-vapor-pressure solvent to form an aged gel; (d) drying the aged gel at ambient temperature and pressure; and (e) heating the dry gel to remove any residual solvents to produce a final ambigel material.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1

| | | Molar Fraction |
|---|---|---|
| | | of MTES to |
| | Precursor(s):EtOH:H2O:Formamide | Total Amount |
| Sample | Ratios | of Precursor |
| TEOS 1 | 1:2:4:2 | 0 |
| TEOS 2 | 1:2:4:1 | 0 |
| TEOS 3 | 1:3:4:0.5 | 0 |
| TEOS 4 | 1:2:8:0.5 | 0 |
| TEOS 5, TEOS | 1:1:4:1 | 0 |
| 5.5 | | |
| TEOS-MTES 3 | 1:2.5:3.5:2 | 0.25 |
| TEOS-MTES 7 | 1:2:4:1 | 0.25 |
| TEOS-MTES 9 | 1:2.5:2.5:2 | 0.33 |
| TEOS-MTES 11 | 1:2.5:2.5:2 | 0.4 |
| TMCS TEOS- | 1:2.5:2.5:2 | 0.4 |
| MTES 11 | | |
| TEOS-MTES 13 | 1:2:4:1 | 0.4 |
| TEOS-MTES 14 | 1:2.5:2.5:2 | 0.5 |

TABLE 2
Example of Structural and Optical Properties of
Synthesized Ambigels About 0.5 mm in Thickness

| | | | Bulk | | | |
|---|---|---|---|---|---|---|
| Alkoxysilane | Drying | Post Gelation | density | Porosity | Transmittance | Haze (%) |
| Precursor(s) | Solvent | Wash | (g/cm³) | (%) | (%) at 550 nm | at 550 nm |
| TEOS | Cyclohexane | None | 1.15 | 47.6 | 96.7 | 2.2 |
| TMOS | Cyclohexane | None | 1.21 | 45.2 | 96.0 | >1 |
| TEOS, MTES | n-heptane | None | 0.491 | 77.7 | 98.3 | 1.4 |
| TEOS, MTES* | n-heptane | TMCS in n- | 0.318 | 85.6 | 79.9 | 5.2 |
| | | heptane | | | | |

*flexible and hydrophobic (contact angle 120°)

What is claimed is:

1. An optically clear thermal barrier, comprising:
a mesoporous metal oxide monolithic slab with a thermal conductivity of 0.1 W/mK or less; an optical transmittance of 85% or greater, and a haze of less than or equal to 5% per 3 mm of slab thickness.

2. The barrier of claim 1, wherein said metal oxide is an oxide selected from the group consisting of silica, titania, zirconia, silica-titania and silica-zirconia.

3. The barrier of claim 1, further comprising:
a transparent substrate coupled to the slab with a transparent adhesive.

4. The barrier of claim 1, wherein said mesoporous slab has an average pore size of less than 25 nm.

5. A thermally insulated transparent panel module, comprising:
a planar transparent panel; and
a thermal barrier comprising a mesoporous metal oxide monolithic slab with a thermal conductivity of 0.1 W/mK or less; an optical transmittance of 85% or greater and a haze of less than or equal to 5% per 3 mm of slab thickness coupled to said transparent panel.

6. The module of claim 5, further comprising a low-emissivity coating on said planar transparent panel.

7. The module of claim 5, further comprising a hard coating on said planar transparent panel to increase scratch resistance.

8. The module of claim 5, further comprising a transparent adhesive coupling said transparent panel and said thermal barrier together.

9. The module of claim 5, further comprising:
a second planar transparent panel coupled to a second thermal barrier of a thermal conductivity of 0.1 W/mK or less; an optical transmittance of 85% or greater and a haze of less than or equal to 5% per 3 mm of slab thickness; and
a frame orienting said second transparent panel substantially parallel to and spaced from said first panel and forming a sealed gap between panels.

10. The module of claim 9, wherein said thermal barrier of said first transparent panel and said thermal barrier of said second transparent panel face each other within said sealed gap.

11. The module of claim 9, further comprising:
a dry inert gas selected from the group of nitrogen, argon, bromine, carbon disulfide, dichlorodifluoromethane and krypton sealed within said sealed gap between the first and second transparent panels.

12. The module of claim 5, further comprising:
a second planar transparent panel with a low-emissivity coating on at least one side of said planar transparent panel; and
a frame orienting said second transparent panel substantially parallel to and spaced from said first panel and forming a sealed gap between panels.

13. The module of claim 12, wherein said sealed gap encloses one or more of a vacuum, nitrogen gas, argon gas, bromine gas, carbon disulfide gas, dichlorodifluoromethane gas, krypton gas and air between the first and second transparent panels.

14. A method for fabricating an ambigel material, the method comprising:
(a) combining one or more silica, titania or zirconia alkoxide precursors, an alcohol and water to produce a solution;
(b) catalyzing the solution with an acid or base catalyst to form a gel;
(c) aging the gel;
(d) exchanging solvents in the aged gel with at least one nonpolar, low-surface-tension, high-vapor-pressure solvent to form an aged gel;
(e) drying the aged gel at ambient temperature and pressure; and
(f) heating the dry gel to remove any residual solvents to produce a final ambigel material.

15. The method of claim 14, further comprising:
placing the solution into a mold to control final shape, thickness and curvature of the ambigel.

16. The method of claim 15, further comprising:
placing a non-interacting liquid of density larger than that of the precursor solution at the bottom of the mold prior to pouring the solution;
wherein interactions between the casted gel and an underling mold surface are minimized; and
wherein roughness of the bottom surface of the mold is reduced.

17. The method of claim 16, wherein said non-interacting liquid comprises a liquid metal or a perfluorocarbon liquid.

18. The method of claim 14, wherein said solvent exchange comprises one or more exchanges of solvents selected from the group of solvents consisting of acetone, ethanol, n-hexane, n-pentane, heptane and cyclohexane.

19. The method of claim 14, said solution further comprising:
a drying control chemical additive (DCCA).

20. The method of claim 19, wherein said drying control chemical additive (DCCA) comprises formamide.

21. The method of claim 14, further comprising:
controlling the molar ratios of silane precursors, alcohol, water and formamide.

22. The method of claim 14, wherein said silica alkoxide precursor is a precursor selected from the group of precursors consisting of tetramethylorthosilane (TMOS), tetraethylorthosilane (TEOS), methyltriethoxysilane (MTES), methyltrimethoxysilane (MTMS), ethyltrimethyoxysilane (ETMS), and vinyltrimethoxysilane (VMTS).

23. The method of claim 22, said solution further comprising:
coprecursors selected from the group consisting of hexamethyldisiloxane (HMDS), hexamethyl-disilazane (HMDZ) and polydimethylsiloxane (PDMS).

24. The method of claim 14, said solution further comprising:
methyltriethoxysilane (MTES) as a coprecursor with TEOS.

25. The method of claim 14, further comprising:
applying a surface modifying wash of a polar or nonpolar solvent to said gel after gelation and before or after aging.

26. The method of claim 25, wherein said modification comprises:
replacing silica ambigel surface (OH) groups with an end group selected from the group consisting of a methyl group, a vinyl group, and a fluorine group.

27. The method of claim 26, wherein said gel surface (OH) groups are replaced with exposure to silane selected from the group consisting of a trimethylchlorosilane (TMCS), a phenyldimethylchlorosilane (PhCS), a triethylchlorosilane (TECS) or a fluorotriethoxysilane.

28. The method of claim 14, further comprising:
drying the aged gel at a reduced pressure between 0 and 1 atmosphere and at a temperature above room temperature.

29. The method of claim 14, further comprising:
drying the aged gel at a pressure below ambient pressure and at a temperature above ambient temperature and below a boiling point temperature of the last solvent used in the solvent exchange.

30. The method of claim 14, wherein said heating of the dry gel comprises calcining the gel to eliminate hydrophobicity and any remaining solvent residues.

31. A method for manufacturing optically-clear and thermally-insulating porous metal oxide slabs, the method comprising:
(a) mixing metal oxide nanoparticles with an aqueous solvent to produce a colloidal solution;
(b) pouring the colloidal solution into a mold of desired shape and dimensions;
(c) evaporating off the solvent from the colloidal solution to form a gel;
(d) ageing the gel; and
(e) drying the gel to remove remaining solvent to produce a final optically-clear and thermally-insulating porous metal oxide slab.

32. The method of claim 31, further comprising:
preparing metal oxide nanoparticles with diameters less than 20 nm, wherein said nanoparticles are smaller than the wavelength of visible light to minimize light scattering.

33. The method of claim 32, wherein said nanoparticles have an average diameter of less than 12 nm.

34. The method of claim 32, wherein said nanoparticles are selected from the group of nanoparticles consisting of hollow metal oxide nanoparticles, core-metal oxide shell nanoparticles and solid metal oxide nanoparticles.

35. The method of claim 31, further comprising:
placing a non-interacting liquid of density larger than that of the colloidal solution at the bottom of the mold prior to pouring the colloidal solution;
wherein interactions between the casted gel and an underling mold surface are minimized; and
roughness of the bottom surface of the mold is reduced.

36. The method of claim 35, wherein said non-interacting liquid comprises a liquid metal or a perfluorocarbon liquid.

37. The method of claim 35, wherein said liquid metal is a liquid metal selected from the group consisting of mercury, gallium and low-melting point metal alloys.

38. The method of claim 35, wherein said perfluorocarbon liquid is a liquid selected from the group consisting of DuPont™ Krytox® oils and 3M™ Fluorinert™ liquids.

39. The method of claim 31, further comprising:
destabilizing the colloidal suspension with an acid before pouring suspension into the mold; and
aging the gel at a temperature above ambient temperature.

40. The method of claim 31, further comprising:
removing the aged gel from the mold; and
exchanging remaining aqueous solvents in gel pores with one or more organic solvents before drying the aged gel.

41. The method of claim 40, wherein said solvents exchanged are solvents selected from the group of solvents consisting of ethanol, acetone, octane and combinations thereof.

42. The method of claim 31, further comprising:
applying a surface modifying wash of a polar or nonpolar solvent to said gel after gelation and before or after aging.

43. The method of claim 31, further comprising:
drying the aged gel at a pressure below ambient pressure and at a temperature above ambient temperature and below a boiling point temperature of the last solvent used in the solvent exchange.

44. The method of claim 31, further comprising calcining the dried gel.

45. The method of claim 31, further comprising:
controlling the concentration of nanoparticles in the original colloidal suspension;
controlling temperature, relative humidity and gas flow environmental conditions during drying; and
controlling the rate of drying to avoid cracking in the slabs.
